(19) United States
(12) Patent Application Publication
(10) Pub. No.: US 2009/0276365 A1
(43) Pub. Date: Nov. 5, 2009

(54) ORDER MANAGEMENT SYSTEM AND METHOD

(75) Inventor: Brian Wilson, London (GB)

Correspondence Address: KNOBBE MARTENS OLSON & BEAR LLP, 2040 MAIN STREET, FOURTEENTH FLOOR, IRVINE, CA, 92614, US

(73) Assignee: EASYSCREEN PLC, London (GB)

(21) Appl. No.: 11/718,330

(22) PCT Filed: Jan. 28, 2005
(86) PCT No.: PCT/GB2005/000318

§ 371 Date: Jun. 18, 2009

(30) Foreign Application Priority Data
Oct. 29, 2004 (GB) 0424090.9

(51) Int. Cl. G06Q 40/00

(52) U.S. Cl. 705/36 R; 705/37

(57) ABSTRACT

The invention relates to a trading system in which an order is received, the order including a predetermined condition. The system determines the data required to fulfil the conditions associated with the order and data is obtained from an external source. The data is monitored to determine whether the predetermined conditions are fulfilled and the order is placed on the exchange if the conditions are fulfilled. The he order is displayed at the trading interface as a single filled or unfilled order.

The present application relates to the field of trading systems and methods and, in particular, to a system for placing orders in an exchange-based trading system.

When a trader wishes to place an order for an asset at an exchange, the order can either be placed directly at the exchange, or the order can be placed via a trading system. For straight forward buy and sell orders, this may be sufficient. However, more complex orders may require a trader to place a number of separate orders at the exchange or to monitor the market closely and react quickly to place orders in response to rapid changes in the market.

Some exchanges provide limited facilities to enable a trader to set a default buy and/or sell price for an asset at the exchange to ensure that a trade occurs at a predefined market value. However, these facilities are limited and inflexible.

Aspects of the present invention aim to ameliorate some of the problems associated with trading at exchanges.

According to one aspect, there is provided a trading system comprising:

means for receiving an order via a trading interface, wherein the order relates to a trading element on an exchange, the order having at least one associated predetermined condition;
means for determining the data required to fulfil the one or more predetermined conditions associated with the order;
means for obtaining the data required from an external source;
means for monitoring the data obtained to determine whether the one or more predetermined conditions associated with the order are fulfilled;
means for placing one or more distilled orders on the exchange if the one or more predetermined conditions associated with the order are fulfilled;
means for displaying the order as a single filled or unfilled order at the trading interface.

Hence, advantageously, even if the order placed by the trader results in multiple distilled orders being submitted to the exchange, the original order may be presented to the trader as a single order. This may enable the trading system to provide a superset of straightforward order types supported the exchanges, whilst also ensuring that the interface used by the trader remains easily comprehensible and fast to use. Hence traders may place complex orders quickly and may monitor and track the orders without being required to interpret a large number of actual or distilled orders placed to the market in response to the complex order. This may increase the speed and accuracy of trading and enable the traders to set up and place more complex orders.

The complex orders of the system may further enable the system to react automatically to changes in market conditions.

A trading system for enabling a trader to trade trading elements in a trading environment, the system comprising:

means for storing a plurality of predefined order types;
an interface for enabling a trader to enter an order for at least one trading element based on a predefined order type, wherein entering the order comprises providing values for a plurality of parameters associated with the predefined order type;
means for analyzing the order to divide the order into at least one monitoring condition and at least one distilled order element;
monitoring means for obtaining data from an external source to determine whether the monitoring condition is fulfilled;
means for placing the at least one distilled order element into the trading environment if the monitoring condition is fulfilled.

Hence the trading system may be provided with predefined order types, for example complex or conditional orders, that may be used by traders to enable orders to be placed into the trading environment. This may allow orders to be placed quickly and accurately, for example in response to market conditions or in advance of changes in market conditions.

In a preferred embodiment, the plurality of parameters associated with the predefined order Type may include at least one of:
a buy/sell price for the order;
a volume of the trading element for the order;
a maximum total value for the order.

A trading system for enabling a trader to trade trading elements in a trading environment, the system comprising:

means for storing a plurality of predefined order types, wherein each order types comprises at least one monitoring condition and at least one distilled order element;
an interface for enabling a trader to create a new order type by combining at least one monitoring condition and at least one distilled order element;
an interface for enabling a trader to enter an order for at least one trading element based on a predefined order type or the new order type;
means for enabling a plurality of traders to enter orders based on the new order type;
means for analyzing the order to divide the order into at least one monitoring condition and at least one distilled order element;
monitoring means for obtaining data from an external source to determine whether the monitoring condition is fulfilled;
means for placing the at least one distilled order element into the trading environment if the monitoring condition is fulfilled.

This may enable a trader to set up a new order type, which may subsequently by used by other traders to place orders. Hence, a group of traders can create and use order types according to their own needs and the system may provide an extensible framework to facilitate the addition of new intelligent order types.

Preferably, entering an order based on at least one order type generates a plurality of distilled order elements. Hence a single order may generate more than one distilled order to be placed into the trading environment. This may allow complex orders to be defined in a single order type.

In a preferred embodiment, at least one order type comprises a conditional order type. That is, the placement of a distilled order element may be conditional on at least one monitoring condition or on the placement of other order elements.

Distilled order elements may comprise at least one of:
an order to buy a predetermined volume of an asset;
an order to sell a predetermined volume of an asset.

Monitoring conditions may be based on at least one of:
market data;
the status of an order or a distilled order element;
risk data, in particular the volatility of an asset;
the time and/or date;
external data.

For example, the external data may comprise weather prediction data.

Market data may comprise at least one of:
the buy or sell price of a trading element;
the mode of the market;
the volume of a trading element;
a change in the price of a trading element;
the rate of change of the price of a trading element;
a change in the volume of a trading element;
the rate of change of the volume of a trading element;
the time to the close of the market.

Preferably, the system further comprises means for determining a risk value associated with the entered order before placing the at least one distilled order element on the exchange.

Further preferably, the risk value is calculated based on SPAN data for the order.

In one embodiment, the exchange may comprise a trading exchange for at least one of:
shares;
commodities;
options;
futures;
currencies.

Preferably, the system further comprises means for enabling a trader to cancel, edit, pause and/or play orders.

Placing a distilled order element on the exchange may be dependent on the status of an existing distilled order element on the exchange. Hence a second distilled order element may not be placed on the exchange or into the trading environment until a first order element has been fulfilled.

In some embodiments, the monitoring condition may be associated with a first trading element on the market and the distilled order element may be associated with a second trading element. Hence orders may not necessarily be placed for the trading elements that are being monitored.

Further aspects may provide methods corresponding to the system aspects described above and computer programs or computer program products for implementing a system or method described in any of the aspects or described herein. Features of the system aspects described above may be applied the method or computer program aspects.

Embodiments of aspects of the system will now be described with reference to the figures in which:

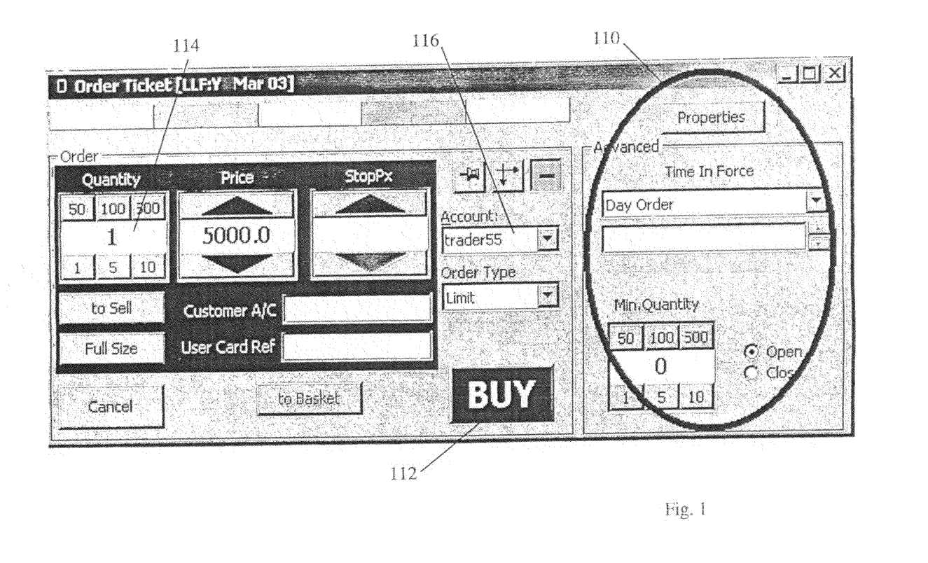

FIG. 1 illustrates an example one embodiment of an order ticket including a value added order section;

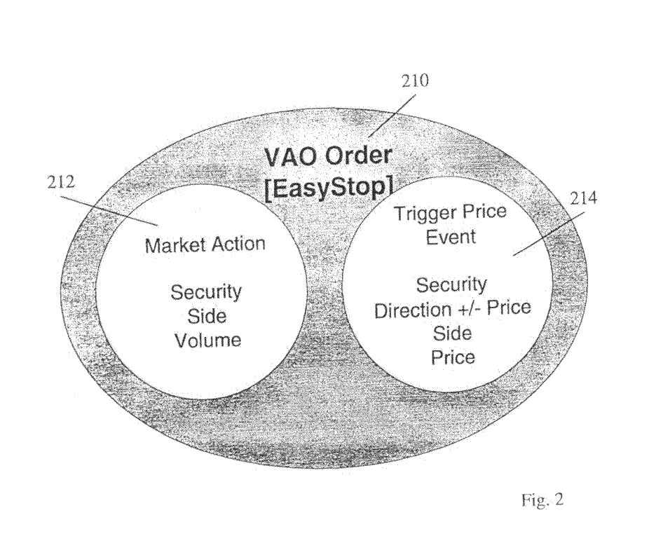

FIG. 2 is a schematic diagram of the structure of a value added order according to one embodiment;

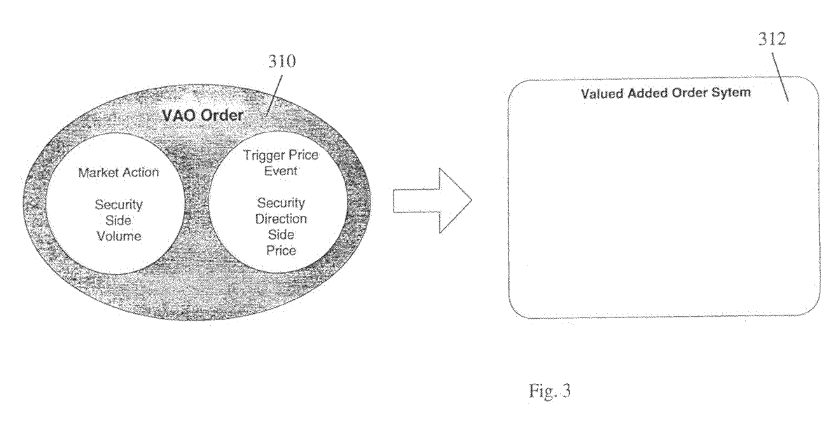

FIG. 3 illustrates schematically the process of sending a value added order to the value added order system according to one embodiment;

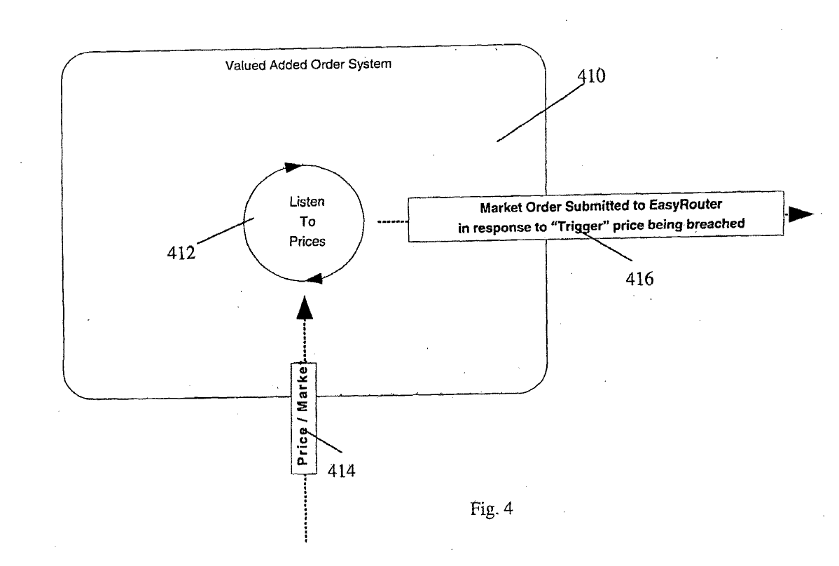

FIG. 4 is a schematic diagram of the process of monitoring market data and submitting an order to the market according to one embodiment;

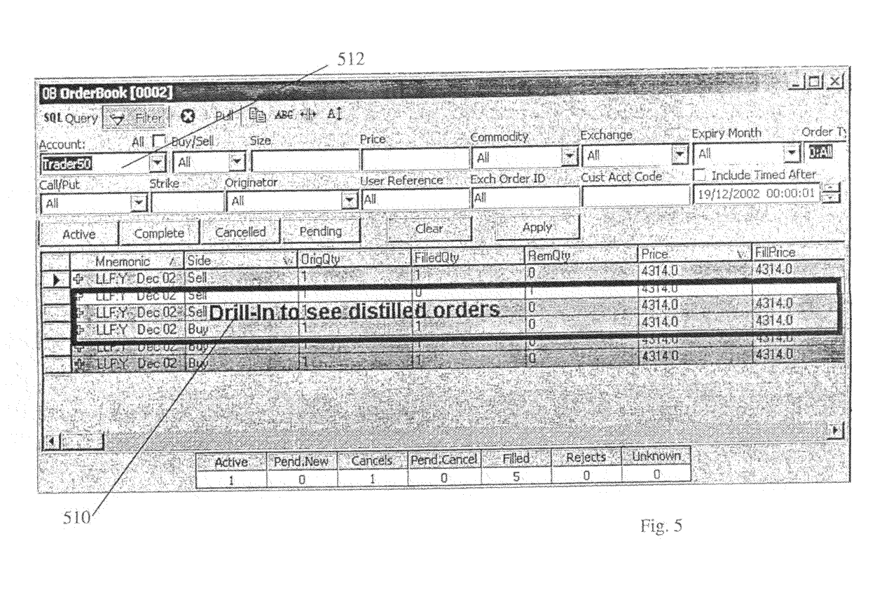

FIG. 5 is a screen shot of the order book of the system according to one embodiment;

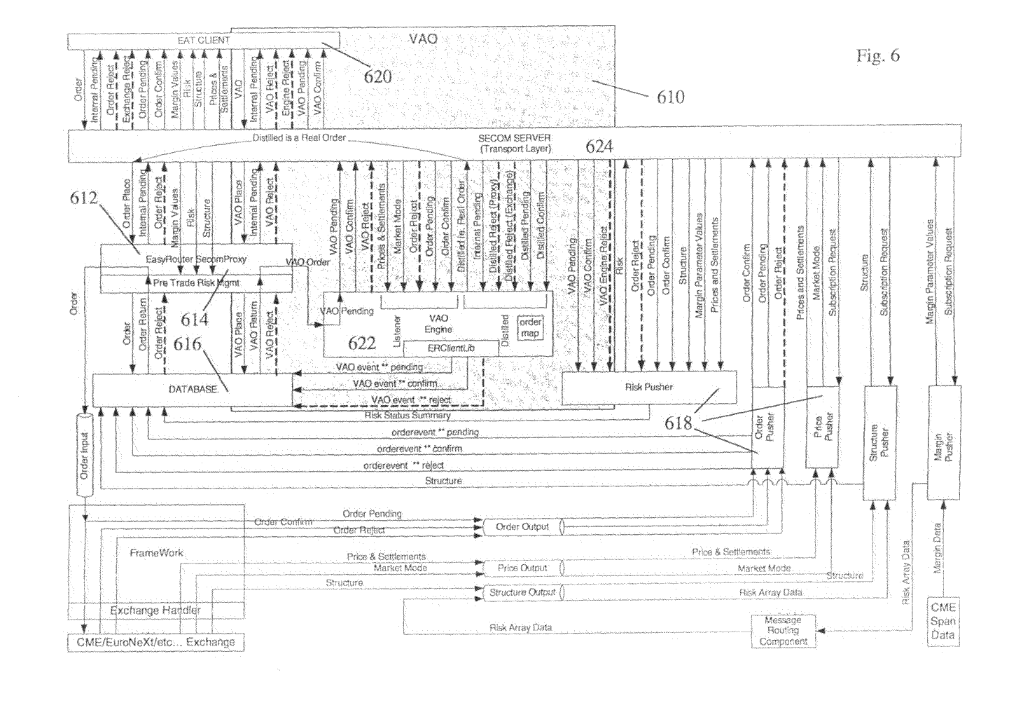

FIG. 6 illustrates one embodiment of the architecture of a VAO system;

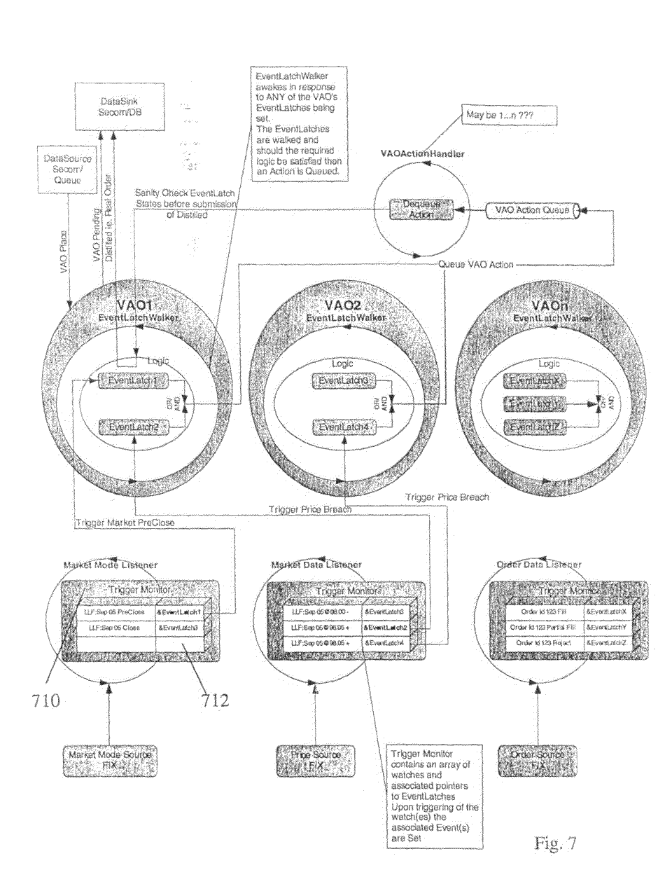

FIG. 7 is a schematic overview of an embodiment of the VAO Pusher or VAO Engine;

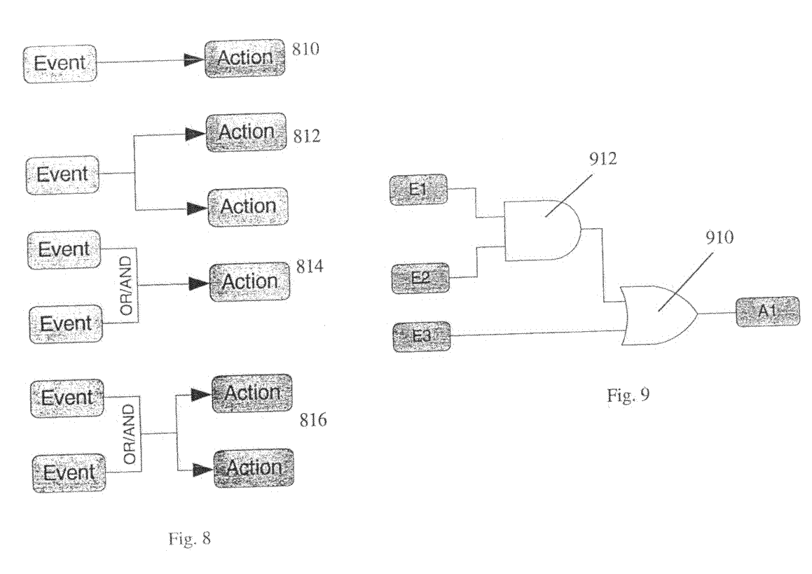

FIG. 8 illustrates Boolean logic that may be implemented in embodiments of the system;

FIG. 9 illustrates one embodiment of an implementation of logic that may be implemented in embodiments of the system;

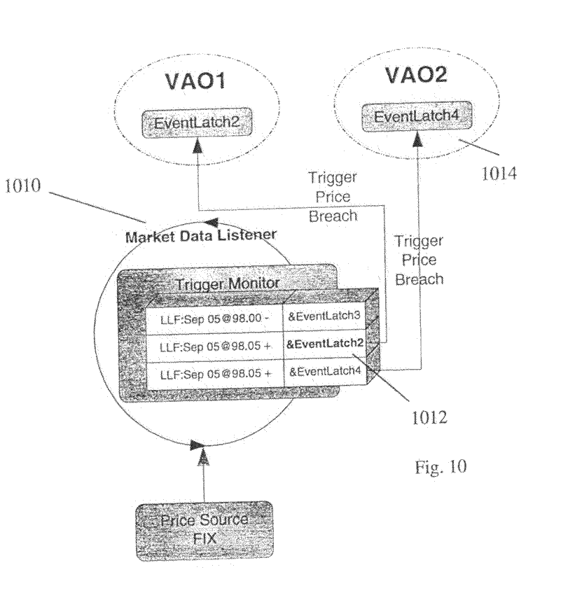

FIG. 10 illustrates an example of an implementation of a value added order according to one embodiment;

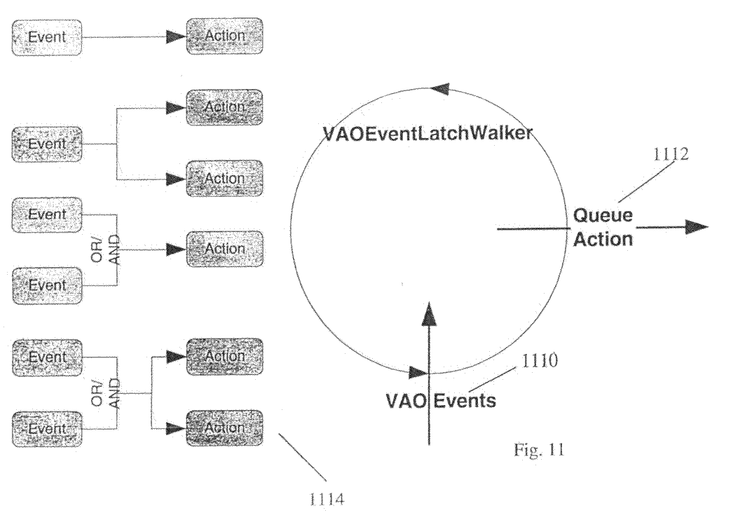

FIG. 11 illustrates one implementation of an embodiment of a value added order event latch walker;

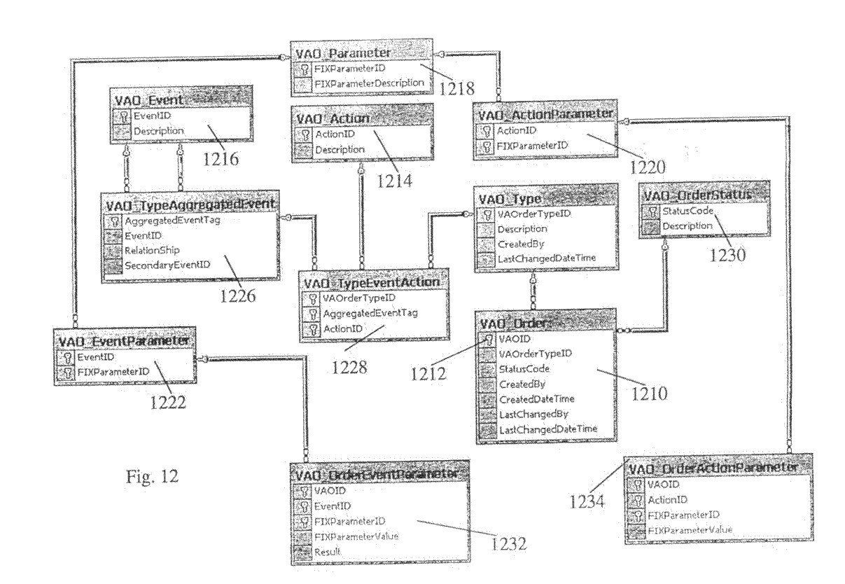

FIG. 12 illustrates schematically objects that may be implemented in the Value Added Order system, interactions between the objects and assets of the objects according to one embodiment.

A description of aspects of one embodiment of a system will now be set out in more detail. This description is not intended to be limiting in any way and it will be clear to one skilled in the art that features described may be provided independently or may be combined and that modifications of detail may be provided.

As used in the following description, the term ‘event’ may be used to describe a notification of a change in market conditions, for example a notification of a price change, a volume change or a trade on the exchange. The term ‘action’ may be used to describe an action to be performed in response to an event, for example, an action may include the placement of an order type directly supported by an exchange. The term value added order (VAO) may be used to describe a combination of the above events and actions. The term ‘distilled or actual orders’ may be used to describe the order entities that are submitted to the exchange.

The description below provides a very high level overview of one embodiment of the envisaged operation of the system discussed in this document.

Custom order types or value added order types can be described as consisting of a set of Events and Actions, for example an EasyStop order type, may be used to place a Market Order when a Stop Price is breached/hit. The order type may be made up of a “Trigger on Price” Event to monitor the market price and determine when a predetermined price is reached and a “Market Order” Action to place the order to market on detection of the price. However, in preferred embodiments, users/traders will not view the custom order type as being an Event-Action coupling but rather refer to the custom order type as a single distinct Order Type, i.e. an ‘EasyStop’ order.

However, regardless of what they are called, it should be noted that the custom order types can be broken down into Event-Action entities as set out above.

To enable a trader to select an order type, the trader may be provided with a mechanism (front-end) that allows them to select custom order types or Value Added Order types. These VAO types may be pre-defined and each one has associated parameters that can be set by the trader.

The VAO types may be presented as an order ticket, or custom order ticket, and may provide facilities to select VAO and enter appropriate parameters. These facilities could be added to an existing order ticket, for example to the highlighted area 110 of the ticket illustrated in FIG. 1. The trader, using the order ticket illustrated, may submit the VAO order to the VAO system by pressing Buy/Sell on, the order ticket 112. The trader can also use the ticket to set parameters such as the quantity to buy or sell 114 and/or the account 116 buying or selling the assets.

When the trader submits the VAO via the order ticket, the order may be broken down by the trading system into actions and events, as illustrated schematically in FIG. 2. The type of order may be defined as an EasyStop order 210, parameters relating to the trigger price event 214 may include the security, the direction (+/−) of the price, the side or the value of the price and parameters relating to the market action 212 may include security, side and volume.

One the order has been broken down 310, as shown in FIG. 2, the order may be submitted to the VAO system 312, as illustrated schematically in FIG. 3. Hence the order is not submitted directly to the exchange, but is submitted to an intermediary VAO system. Once submitted to the VAO system, the order may appear as Active in the order book of the system and may have an order TID (which may be known as a BOID) on the router that interfaces with the exchange (which may be termed the EasyRouter). The VAOs may be identifiable and distinguishable from standard orders, for example by colour coding or by a VAO type identifier.

As illustrated schematically in FIG. 4, the VAO system 410 decodes the submitted VAO to break down the event action from the VAO submitted and, based on the contained events sets up internal monitors 412 which listen to Exchange Activity; Price, Mode, Trades 414 etc. If the monitors detect the event/condition for which it was set up, the VAO system 410 may react by submitting 416 the appropriate order type (real, actual or distilled order type) to the exchange via EasyRouter.

As described above, when the VAO system may submit the distilled order (a market order) to the router and this order may appear under the VAO within the order book of the system, one embodiment of which is illustrated in FIG. 5. As illustrated in FIG. 5, the order book may allow orders in the system to be sorted and reviewed. Parameters 512 may be set to determine the orders that are displayed, for example the account name, the exchange on which the orders are being placed and the time at which the orders are submitted.

As described above, an order may comprise a number of distilled orders and the order book preferably initially shows only the overall order. However, as indicated on FIG. 5 at 510, it may be possible to select an order to see more information about the order, including details of distilled orders associated with the order.

Features of a system that may implement the method described above may include:
Providing the value added functionality of being able to create intelligent automated orders within EasyRouter. For example EasyStops, Iceberg and Invisible Order Types as described in more detail below.
May be implemented as a Plug-n-Play Add-On to EasyRouter. Slot-in, Slot-out may enable clean upgrade path, minimal regressive impact, and may allow the system to be implemented as an “Add-On” to existing systems.
The system should be exchange independent in so far as this is possible.
The system should be client independent in so far as this is possible.
The system should be recoverable, that is the Value Added Order system should be able to recover a previous set of Value Added Orders.
The system should be fast, to avoid the possibility of missing market opportunities, or not triggering automated orders in fast markets.
The system should be scalable, to support an increasing number of users.
The trader may be provided with—place, view, cancel, pause and play access.
The administrator may be provided with—view, cancel, pause and play access.
The trader interface may allow the trader to determine whether or not the VAO Engine is healthy.
The administration interface may allow an administrator to determine whether or not the VAO Engine is healthy.
The system should be extensible to enable new value added order types to be added to the system quickly.
The system should be defensive in nature in that should an error occur the safest action is taken. This strategy reduces the scope for unwanted trades originating from within the automated element of the VAO System when something goes wrong.
Primed orders within the VAO system with similar trigger characteristics should be fired in order of submission and with no latency.
Value Added Orders should be identifiable and cross-referenced to distilled (actual) orders within the system.
The VAO system/service should be clearly identifiable within an installation and clearly visible within the Admin Tool.
The system may be provided as a Middle Tier Financial Information Exchange (FIX) Message based solution, thereby insulating front and back from logic required to implement Value Added Orders and provide a defined interface to the VAO system
The system may be implemented not as an attempt to make exchanges appear homogenous, but rather as a suite of value added functionality, which may make the system easier to develop and maintain.
Each Value Added Order Type should be discrete to facilitate flexible marketing/charging; however clients should be able to mix-n-match from these discreet value added order types to develop their own VAOs.
Value Added Orders should be risk permissioned and form part of the position calculations.

The functionality and example features of embodiments of a client device that may be implemented in conjunction with the present system will now be described in more detail.

Three example custom order types that may be supported in the present system may be:

### EasyStop

### EasyIceberg

### EasyInvisible

These VAOs are preferably supported as intraday VAOs supported initially.

The placement of the above custom order types (VAOs) directly from a trading client may be via an order ticket, as illustrated above. The trader may select from these pre-defined well-known VAO types on the order ticket, which depending on the order type, may present additional details to be entered.

The trading client may then be able to Edit/Cancel/Pause/Re-Start VAOs. Should an attempt be made by the trader to edit/cancel the distilled orders from the trading client, a warning may be displayed. This edit or pull may invalidate and pause the VAO.

If the trader wishes to edit a VAO, this may be done on the parent, that is on the VAO from which the distilled orders originate. Trader actions on VAOs may be supported from the client front end and may include:
Cancel/Pull—resulting in the cancelling of any placed distilled order and cancellation of the VAO.
Edit—limited Edits may be supported, however if any distilled fills have occurred then the VAO can only be cancelled. If no fills have occurred then any distilled orders in the market will be pulled, then the edit will occur and the triggers set up again with the new parameters.
Pause—may cause distilled orders on the Exchange to be cancelled/pulled. The VAO will remain within the VAO, but will not monitor the market.
Play—from a paused state, this may re-create the market monitors.

The VAO preferably appears in the order book window when processed and acknowledged by the VAO system. When distilled orders are submitted to the Exchange these may appear as normal active/filled orders within the client. A VAO is deemed to be filled when all its distilled orders have been filled. Traders can view active VAOs, filled VAOs etc. and drill-in to view the constituent distilled/actual orders (i.e. the actual market/limit orders) as outlined above.

The VAO system may be implemented as a defensive system, so on Market Close/Host Failure all intraday Value Added Orders on that Exchange may be paused. The onus is then on the trader to decide what to do, for example to resume or cancel the Value Added Order. Under such failure conditions notification may be fed to the trading client, via the order tracker, status screen etc.

In one embodiment, the trading client may report the health of various channels via icons (green=ok) on the bottom right-hand corner of the trading screen. VAO health may also be reflected within this component status view.

Support for further custom order types composed of the events and actions, including those listed below may be added. In further embodiments, support for mix-n-match order characteristics may be added.

Copy and saving of mix-n-match VAO definitions may also be supported. VAO's may also be edited, ie. their behaviour/characteristics altered, although VAO's, which have been used to place actual orders, may be prevented from being edited, and may be marked as archived.

Features of the administrative functionality of one embodiment of a system will now be described.

A VAO Pusher to push orders to market may be controlled and configured using standard pusher mechanisms associated with the router. The Value Added Order state is preferably visible at all times from the admin screens. The information may be obtained from the database persisted VAO state via COM+ components. Administrators of the system may be provided with the ability to view/cancel/pause/re-start Value Added Orders and drill-in to their constituent distilled (actual) orders (filled/active etc. . . . ). The administrator may also be able to cancel these distilled orders.

The interfaces on the router, for example the EasyRouterAdmin's Active, Filled and Pulled views, should display VAOs in a readily identifiable way. Active Orders and Filled Orders views should further support drill-in to actual/distilled orders. The administrative tool of the router should support the cancel, pause and re-start of VAO's and may further report on the health of various VAO Pushers within the system. While this can leverage off existing Pusher Status mechanisms, for example a ComponentStatus mechanism, this functionality may still have to be implemented in the VAO system.

In further embodiments of the system, the administrative tool of the router may provide a mechanism whereby by an Administrator can flatten an account's position by submission of a ‘Flatten Position Hard’ or ‘Flatten Position Soft’ VAO from the administration interface. An account may also have Auto-Flattening upon Risk Breach associated with the account.

The operational functionality of embodiments of the system described herein will now be described in more detail. The VAO Engine may be implemented as a “pusher” of sorts and as such may publish component status, and be configurable from the Administrative Web Site. The VAO system is preferably recoverable, that is upon system start-up the VAO can recall its previous state. Taking a defensive stance towards recovery may mean that any custom orders recreated upon recovery will be in a “paused” state. Traders may be informed through the trading client systems that a VAO has been recovered. The onus is then on the trader to “re-start” the VAO.

In further embodiments, usage stats on the number, type and source of VAOs' may be collected by each VAO Engine. The collected stats may then be presented in reports, for example via web administration or other report.

In a preferred embodiment, the VAO system may be implemented as a scalable system, consisting of a number of highly available engines. More and more VAO Engines can be added into an installation, as scaling requirements dictate. Each VAO Engine may be configured and explicitly associated with 1 . . . n clearers.

The architecture of embodiments of the present system will now be described with reference to FIG. 6, which illustrates one embodiment of the architecture of a VAO system.

As can be seen from FIG. 6, the Value Added Order System 610 may be implemented in conjunction with a router 612, the ‘EasyRouter’ system, nestled between the SecomProxy 614, a database 616 and pushers 618.

Communication to and from the VAO system 610 may be via FIX Messages, with the exception of VAO Events being written to the database 616.

When a client 620 (for example, application/html) wishes to place a VAO, a FIX Message, representing the VAO placement request, may be routed via SecomProxy 614 to the VAO Engine 622. The VAO Engine 622, an independent service pusher, may consume the VAO Requests, decode the message and set up the VAO Order internally with its appropriate triggeis.

The Value Added Order may be stored internally within the VAO Engine 622. The trigger monitor listens to market data (price etc.), order actions and market mode via the standard pusher channels as illustrated. Different VAO's may be triggered under different conditions. Upon triggering, the VAO Pusher may submit an appropriate “distilled order” via the standard EasyRouter Order Routing mechanisms. If placement of the distilled order is successful or fails, this may be reported back to the VAO system 610 via the SECOM Order Channels. The VAO system 610 may react to the PendingNew, PendingConfirm, Rejects etc. and take the action appropriate to the Value Added Order Type; e.g. set up another trigger, provide state feedback on the VAO to the client, the database etc.

By leveraging off existing functionality within EasyRouter 612 the VAO system 610 may gain EasyRouter's 612 checking, error handling, order feedback etc. mechanisms for the distilled orders and only the mechanisms for checking, error handling, order feedback etc. for the parent Value Added Order will need to be added.

From a database 616 point of view the Value Added Order may be persisted in existing order tables, such as EasyOrder and EasyOrderEvent.

One embodiment of a non-limiting example of a process is described in more detail below.

The client 620 sends a “New VAO Order”/“VAO Place” FIX Message over Secom 624 to the SecomProxy 614. Recognising a VAO, the SecomProxy 614 issues a “FastTrackOrderSubmit” into the database 616, “VAO Place”, which allocates ESBOIDPrimary, this ESBOIDPrimary becomes the VAOID i.e. ESBOIDPrimaryOfParent etc. The VAO FIX Message (potentially embellished) may then be sent (via Queue or Secom 624) to the VAO Engine 610, “VAO Order”.

Upon receipt of the FIX Message, the VAO engine 610 may perform the following steps:
Writes a VAO Pending Event to the database 616 and sends a VAO Pending SECOM FIX Message.
Then the FIX Message is decoded and the Appropriate Listeners (Market Data, Market Mode, Order, Risk Status) are instantiated and the associated Event Handlers registered. Listeners are pieces of logic that listen to the environment.
Once the Listeners have been set up, a VAO Confirm Event is written to the database 616 and VAO Confirm SECOM FIX Message sent back up to the SecomProxy/Client.
Conversely, failure to setup the Listeners and Monitors results in a VAO Reject Event being written to the database and VAO Reject SECOM FIX Message sent back up to the SecomProxy/Client.

The VAO upon satisfaction with the event criteria for a distilled order release may submit the distilled order to the SecomProxy 614 via Secom 624.

The SecomProxy 614 may treat the distilled order as a standard Market or Limit Order and route the Order as normal to the Exchange connection using the following steps:
An Internal Pending Secom FIX Message from the Proxy 614 for the distilled order will be picked up by the VAO Engine 610.
Equally a Reject from the database 616 will cause the “Order Reject” message to be picked up as a “Distilled Order Reject (Proxy)”.

Feedback from the exchange for this order may be relayed to the VAO Engine 610 (and client 620) via the OrderPusher 618 according to the following rules:
An Order Pending from the Order Pusher 618 comes to the VAO Engine 610 as a “Distilled Order Pending”.
An Order Confirm from the Order Pusher 618 comes to the VAO Engine 610 as a “Distilled Order Confirm”.
An Order Reject from the Order Pusher 618 comes to the VAO Engine 610 as a “Distilled Order Reject”.

All feedback related to the VAO Order and Distilled order may be routed to the client 620.

As set out above, FIX messages and, in particular, FIX 4.3 compliant messages may be used to describe the submission, acknowledgement and rejection of VAOs. In the case of submission, the VAO Pusher/Engine may separate out the Events and Actions contained within these messages. Each Event may require the setting up of a Trigger Monitor within the Listener thread(s). The EventHandler may then register an interest in these Events coming from the Trigger Monitor. The Actions associated with this Event may also be staged within the VAO Pusher.

Suitable FIX 4.3 compliant messages may be specified, to support placement, pausing and cancellation of VAOs. To fully describe VAOs and provide linkages between parents and children the FIX Tags, Enums and repeating groups used may be extended.

A new tag, ESBOIDPrimaryOfParent, may be used to provide the mechanism by which VAO/Parent orders and their respective Distilled/Child Orders can be linked. Within the internal order maps etc. of modules, a top level VAO may then be identifiable by the fact that ESBOIDPrimary and ESBOIDPrimaryOfParent are the same value. A distilled order may be identifiable by the fact that ESBOIDPrimaryOfParent is set within the FIX message. A vanilla standard (non VAO) will not have the ESBOIDPrimaryOfParent field set within the FIX Message. This is summarised in the table below:

| | ESBOIDPrimaryOfParent |
|---|---|
| VAO | Same as ESBOIDPrimary of this actual |
| | message, ie. child of self. |
| Distilled | Set to the ESBOIDPrimary of the |
| | VAO/Parent |
| Standard | Tag not present in the FIX Message |

This schema maps the relationship between VAOs and their respective distilled orders, such that it is clear (upon examination) of a FIX message pertaining to an Order Fill/Reject/Pending that it is standalone or a parent VAO or a distilled order. The above schema further allows for chaining of VAO's themselves. FIX enhancements may further be provided to associate events and actions.

An overview of an embodiment of the VAO Pusher or VAO Engine will now be provided with reference to the schematic overview illustrated in FIG. 7.

The VAO Pusher/Engine may be used to monitor trigger conditions 710, house the Value Added Order, place distilled orders via the router and react to distilled order placements/rejects/fills etc. In one embodiment, the VAO Pusher/Engine may be based on standard Pusher Architecture and may source FIX Messages (VAO New Requests, VAO Edits, and Cancels) via either a DataSourceMSMQ or DataSourceSecom object.

Upon receipt of the FIX Message, the VAO engine returns a VAO Pending SECOM FIX Message. Then the FIX Message is decoded and the Appropriate Listeners 710 (Market Data, Market Mode, Order, Risk Status) with their internal Trigger Monitors are instantiated and the associated Event Latches 712 primed. Listeners are pieces of logic that listen to the environment. These listeners may contain monitors that trigger upon the occurrence of a certain event.

If triggered the VAO Pusher makes a fast, automatic decision as to what is to be done. This may result in the automatic placement of a distilled order whose properties are determined from the internal properties of the Value Added Order. This placement is through the router mechanisms. Distilled Orders may be distinguishable from standard router orders by the presence of a ESBOIDPrimaryOflarent field within the FIX message.

Each VAOPusher may contain some or all of the following objects:
DataSource (MSMQ/Secom)—FIX Messages representing the submission, editing and cancellation of VAO may originate from MSMQ or /Secom. Irrespective of route these FIX Message will be identical. VAO requests are validated, and then created internally within the VAO Pusher's internal structures; this processing will also be reflected within the database.
a DataSink (DB/Secom)—Acknowledgements and pendings may be committed to the database and routed back to clients over Secom.
MarketDataListener—This object/thread listens to Price and Market Mode information coming from a FIX data source.
OrderDataListener—This object/thread listens to Order information coming from a FIX data source.
Trigger Monitor—The Trigger Monitor contains a list of watch items and associated references to the respective EventLatch objects. These represent the specific trigger conditions required for the events that the VAOEventLatchWalker is interested in. Price updates from the Listener may be distributed over all EventHandlers allowing them to make the decision as to whether to ignore the price update or not. In an alternative embodiment, the Trigger Monitor within the Listener may inspect the price update. Should the price update breach one of the registered benchmarks, then this event may be fired to all Event Handlers that registered an interest. The latter option may be the more efficient implementation.
VAOEventLatchWalker—This object asynchronously walks the states of all event latches within a VAO in response to the latch state being change by a Trigger Monitor. Upon satisfaction of the required conditions will indicate to the VAOActionHandler that a distilled order is to be placed, by queuing a pending action.
VAOActionHandler—This object performs the distilled actions against EasyRouter proper, i.e. the submission of an actual market order in response to the trigger price of an EasyStop being breached. Internally the ActionHandler de-queues a pending action and performs a sanity check on the latched states of the events that caused the pending action to be queued. This double checking is may avoid the events being missed for latency reasons or other.

As illustrated schematically in FIG. 8, Event/Action associations can be one-to-one 810, one-to-many 812, many-to-one 814 and many-to-many 816, hence an intelligent storage/mapping mechanism within the VAO Pusher itself (aside from the database) may be provided. This mechanism should be flexible and facilitate rapid lookup/association. As illustrated in FIG. 9, Event/Action associations may further support ORing 910 and ANDing 912.

For example, the logical expression, “E1.E2+E3=A1” may be interpreted as: “Perform Action(A1) if Event (E1) AND Event (E2) occurs OR Event (E3) occurs”.

To facilitate flexibility and extensibility of Value Added Order Types the logic rules which will result in the placement of a Distilled order may be represented within a VAO in an internal VAOEventArray. The VAOEventArray may associate 1 . . . n Events with 1 . . . m Actions.

For example:

| | | | | |
|---|---|---|---|---|
| Tag | Event | Logic | Event | Action |

Perform Action(A1) if Event (E1) occurs

| | |
|---|---|
| E1 | A1 |

Perform Action(A1) and Action(A2) if Event (E1) occurs

| | |
|---|---|
| E1 | A1 |
| E1 | A2 |

Perform Action(A1) if Event (E1) AND Event (E2) occurs

| | | | |
|---|---|---|---|
| E1 | AND | E2 | A1 |

Perform Action(A1) if Event (E1) AND
Event (E2) occur OR Event (E3) occurs.
E1.E2 + E3 = A1

| | |
|---|---|
| Event 1 AND Event 2 | => Do Action 1 |
| Event 3 | => Do Action 1 |

| Tag | Event | Logic | Event | Action |
|---|---|---|---|---|
| | E1 | AND | E2 | A1 |
| | E3 | | | A1 |

More complex rules may require the use of abstraction for example:

Perform Action(A1) if Event (E1) AND Event
(E2) AND Event (E3) occurs.
E1.E2.E3 = A1

| Tag | Event | Logic | Event | Action |
|---|---|---|---|---|
| Ea | E1 | AND | E2 | |
| | Ea | AND | E3 | A1 |

Perform Action(A1) if Event (E1) AND Event (E2)
occur OR Event (E3) occurs but NOT if
Event(E4) occurs.

(E1.E2 + E3).E4 = A1
≡E1.E2.E4 + E3.E4 = A1

| Tag | Event | Logic | Event | Action |
|---|---|---|---|---|
| Ea | E1 | AND | E2 | |
| Eb | E4 | NOT | | |
| | Ea | AND | Eb | A1 |
| | E3 | AND | Eb | A1 |

In one embodiment, the above code may be implemented as software, alternatively at least some of the VAO order types may be hard-coded. This schema may be laid out as follows:

Taking EasyStop as an example—This specialisation of the base VAO would contain a Price Breach EventLatch and a Market Order submission Action. Should the EventLatch be triggered the EventLatch Walker will instigate the queuing of the Market Order Submission.

This “hard coding” approach to this subset of the system may be used to run the system for the most important VAOs and then the generic event action logic system may be implemented subsequently.

The VAO Pusher may have several threads listening to market events such as prices, orders, market modes. For example, two Data Listeners may be implemented:

MarketDataListener—listening to price, market mode and volumes etc. . . .
OrderDatatistener—listening to order fills, rejects etc. . . .

Other Listeners may include position e.g. a RiskDataListener.

The breakdown and granularity of these threads should be set up to ensure a balance between resource usage and responsiveness. For example, one thread monitoring everything may mean a lot of sequential processing with implicit latency, whereas, one thread for every single event will not scale.

In one embodiment, a Trigger Monitor may sit inside each Listener thread. For example a Trigger Monitor may be used to watch for a upwards Price breach on LLF:Sep 05. This Trigger Monitor will sit inside the Market Data Listener thread that is listening to FTSE100 prices. Should the price be breached, the Trigger Monitor preferably notifies the associated VAOEventLatch object.

It is noted that several VAOs with identical trigger conditions can have identical watch conditions within the Trigger Monitors. Should the market condition of the watches be met then EventLatches of all these objects may be notified or latched.

Taking the example illustrated in FIG. 10, the Market Data Listener 1010 has a Trigger WatchList 1012 containing Price Watches and their respective EventLatch Object references, pointers. Should the Market Data Listener detect and upwards price breach of 98.05 on LLF:Sep 05 the EventLatch2 within VAO1 will be set and then EventLatch4 1014 within VAO2 will be set.

In one embodiment an VAO Event Latch Walker may be provided as a worker thread within the VAO Pusher/Engine and may be responsible for the asynchronous checking of Events 1110 and subsequent queuing of Actions 1112, as illustrated in FIG. 11. When an EventLatch object is set this implicitly queues a “Check all events” task on the VAOEventLatchWalker thread. The queuing of the “Check all events” task ensures non-throttled dispatch of trigger notifications from the trigger monitors. The asynchronous processing of this, “Check all events”, task cycles over all EventLatch objects comparing their respective Latch states to the stored boolean logic 1114. Should the logic be satisfied the associated VAO Distilled Order, Action(s), is queued against the VAOActionHandler.

In the present embodiment, these Actions will be queued (as FIX Messages) on the VAO Action Queue (internal not MSMQ) to ensure that the processing of the Distilled Order does not impact on the VAOEventLatchWalker thread's processing.

At least one VAOEventHandler object may be provided for every VAO placed in the system, Icebergs (described below) may well have one per tranche ie. one waiting for the previous tranche to fill before taking the action of queuing a new order placement action.

The VAO Action Handier object synchronously processes queued VAO Actions on its worker thread. The first step is to sanity check the underlying events against the persisted latch event states within the associated VAO object. This insulates the VAO system from the Market changes occurring beneath it and mitigates against chasing the market etc. If the event latch states are still ok, then the Action is performed against EasyRouter and the next message is processed. Note, should the Sanity check of latched states of events fail, and then the queued action may be discarded and a warning may be issued to the creator of the VAO and/or the administrator.

One VAOActionHandler object may be provided within each VAOPusher thus ensuring that VAO orders are Actioned in order of action queuing, thus implementing a “process in order of submission” feature.

The VAOActionHandler can deal with de-queue action requests in either of two ways:
Queue a “Perform and Sanity Check” task against the VAOEventLatchWalker thread. This task, if successful causes the submission of the Distilled Order described therein.
Synchronously check the Event Latch States from the VAOActionHandler thread.

The VAO Pusher has its current state persisted to the database. This may ensure a recovery path and provide administrators with a view of the VAO Pusher state. As with other pushers, the database updating mechanism may be through the inherited C++ classes.

Elements of the system may include:

DataSourceDB—Database reading mechanism
DataSourceMSMQ—MSMQ reading mechanism—to read FIX Messages for the placement, cancellation and pausing of VAOs.
DataSourceSecom—SECOM reading mechanism—to listen to Price, Market Mode, Order data within the Event Capture.
DataSinkDB—database writing mechanism
DataSinkSecom—SECOM writing mechanism for the relay of FIX Messages

### Market Data Listener Thread

### Order Data Listener Thread

### Trigger Monitor

### VAO Event Latch Walker

### VAO Action Handler

### VAO Order Map

VAO Order Event/Action mappings

### VAO Order State

### VAO Order Control

### VAO Order Response

### VAO Order State Persistence Thread

In the present implementation, there are two VAO business objects. One performs Admin Views (drill-in etc. . . . ) and the other facilitates the placement, pausing, cancelled and restarting of VAOs from COM clients.

The VAO View component may interact directly with the database to provide visibility of VAOs on a particular VAO Engine, all VAOs with drill-in support.

The VAO Control/Placement component takes Value Added Order requests, validates them, stores the VAO details in the database, attaches the DB generated VAOID (if necessary) to the message and places this message on the VAO Queue. The VAO Control/Placement component will determine the best VAO queue onto which to place the generated FIX Message via round-robin and loading characteristics determined from the database.

These components may be written in C++, utilise MessageFIX3 (non-COM interface), and can sit inside or outside of COM+.

The components may include:
Interface
Database links
FIX Message Queuing (Secom or MSMQ or both)

FIG. 12 illustrates schematically objects that may be implemented in the Value Added Order system, interactions between the objects and assets of the objects.

In the implementation of VAO Database elements, tables and supporting stored procedures may be used to store the VAO definitions and their individual instances with parameters. The [VAO_Order] 1210 table may hold the Value Added Order and this table's key, [VAOrderID] 1212, may be used to uniquely identify the Value Added Order throughout the system. Also this [VAOrderID] 1212 may be associated with all distilled orders. These distilled orders will appear in [EasyOrder] as normal orders, save for the presence of a [VAOrderID] 1212 in the appropriate [Parent] column on that table. Two distinct types of information may be persisted within the database: definition and state.

VAO Definition—Tables and stored procedures may be used to store the VAO Types within the database, one embodiment of which is set out in more detail below:

The VAO_Action table 1214 may contain an ID and Description that represent Value Added Order Actions. By combining several Actions into a VAO any desired custom order type may be synthesised.

| Column | Description |
|---|---|
| ActionID | ID to identify the action |
| Description | User Friendly description of the action |

The VAO_Event table 1216 may contain an ID and Description that represent Value Added Order Events. By combining these Events into a VAO any desired custom order type can be synthesised.

| Column | Description |
|---|---|
| EventID | ID to identify the event |
| Description | User Friendly description of the event |

The VAO_Parameter table 1218 may contain an ID and Description that represent Value Added Order Action/Event Parameters.

| Column | Description |
|---|---|
| FIXParameterID | Parameter Identifier FIX where available and |
| | EasyScreen FIX for others |
| FIXParameterDescription | User Friendly description of the parameter |
| | will be the FIX Tag for FIX Fields and |
| | EasyScreen defined for others |

The VAO_ActionParameter table 1220 may contain the ID and parameters associated with that Action.

| Column | Description |
|---|---|
| ActionID | An ID to identify the action |
| FIXParameterID | Parameter Identifier FIX where available and |
| | EasyScreen FIX for others |

The VAO_EventParameter table 1222 may contain the ID and parameters associated with that Event.

| Column | Description |
|---|---|
| EventID | An ID to identify the event |
| FIXParameterID | Parameter Identifier FIX where available and |
| | EasyScreen FIX forothers |

The VAO_Type table 1224 may define custom order types. The definition of an EasyStopMarketOrder will be stored in this table with an appropriate user-friendly label and a system identifier, VAOrderTypeID. This table will be pre-populated with predefined custom Order types such LimitStop, etc.

| Column | Description |
|---|---|
| VAOrderTypeID | An system id to identify the VA Order Type |
| Description | User Friendly description of what this Value |
| | Added Order is |
| LastChangedBy | SessionId of user who changed the order type |
| LastChangedDateTime | DateTime of creation/last revision of this custom |
| | order type |

The VAO_TypeAggregateEvent table 1226 may contain the mappings between the VAOrderTypeID held on the VAOrderType table and the multiple Events from which the custom order type is composed. These events can be ORed/ANDed etc. The aggregation facilitates the composition of complex logical relationships.

| Column | Description |
|---|---|
| VAOrderTypeID | An system id to identify the VA Order |
| | Type |
| EventID | Id of the Event to listen for |
| SecondaryEventID | Id of the Event to listen for |
| (optional) | |
| RelationShip (optional) | AND/OR/NOT |
| AggregatedEventTag | Identifier for the inter-event relationship being |
| | aggregated |

The VAO_TypeeventAction table 1228 may contain the mappings between the VAOrderTypeID held on the VAOrderType table the Aggregate Events and the Action(s) to be performed. Note there may be multiple Actions so three columns may be used.

| Column | Description |
|---|---|
| VAOrderTypeID | An system id to identify the VA Order Type |
| AggregatedEventTag | Identifier for the inter-event relationship being |
| | aggregated |
| ActionID | The Action to be performed in response to the |
| | aggregated events occurring. |

VAO State—Tables and stored procedures may be used to store actual instances of VAOs, ie their parameters and state, within the database.

The VAO_OrderStatus table 1230 may contain the definitions of the valid states a VAO can be in; eg. Paused, Active, Cancelled, Filled etc.

| Column | Description |
|---|---|
| StatusCode | Status Identifier |
| Description | Description of the Status |

VAO_Order table 1210—the Value Added Order, once validated, may be stored on this table keyed by a generated VAOID and a foreign key to a VAOrderTypeID with full Order parameter details held on VAO_OrderEventParameters and VAO_OrderActionParameters.

| Column | Description |
|---|---|
| VAOrderID | The ESPrimaryBOID or EasyOrder..OrderID |
| VAOrderTypeID | An system id to identify the VA Order Type |
| StatusCode | Paused, Active, Filled, Cancelled |
| CreatedBy | Session Id of the user that created the VAO |
| CreatedDateTime | TimeStamp (UTC). |
| LastChangedBy | Session Id of the user that last changed the VAO |
| LastChangedDateTime | TimeStamp (UTC). |

The VAO_OrderEventParameter table 1232 may hold all Order Event parameter details with the true/false state of the event, i.e. true when it has been fired.

| Column | Description |
|---|---|
| VAOrderID | The ESPrimaryBOID or EasyOrder..OrderID |
| EventID | ID that identifies the event |
| FIXParameterID | Parameter Identifier FIX where available and |
| | EasyScreen FIX for others |
| FIXParameterValue | Value associated with the parameter for this event. |
| Result | Boolean (true/false) |

The VAO_OrderActionParameter table 1234 holds all Order Action parameter details with the true/false state of the event, i.e. true when it has been fired.

| Column | Description |
|---|---|
| VAOrderID | The ESPrimaryBOID or EasyOrder..OrderID |
| ActionID | ID to identify the action |
| FIXParameterID | Parameter Identifier FIX where available and |
| | EasyScreen FIX for others |
| FIXParameterValue | Value associated with the Parameter for this Action |

Custom Order Types or Value Added Order Types can be described as consisting of Events and Actions, as set out above. For example, an EasyStop, may mean ‘place a Market Order when a Stop Price is breached/hit’, and may be made up of a “Trigger on Price” Event and a “Market Order” Action. However users/traders will not view the custom order type as being an Event-Action coupling but rather refer to the custom order type as a distinct Order Type, ie. EasyStop, Market If Touched etc. However, as set out above, custom order types can be broken down into Event-Action entities. The combination of these Events and Actions in a meaningful way yields a Value Added Order.

Examples of actions that may be implemented in the system described herein will now be set out in more detail.

Where an Exchange does not support an Order Type the VAO may provide Valued Added Functionality to mimic the said Order Type. The presence an indicator, with no additional properties, may indicate to the VAO Engine that the Exchange does not directly support the associated order type within the VAO and that the VAO will have to roll its own implementation.

| | |
|---|---|
| Special Fields | Description |

None

A market order indicator may be used to indicate that the order does not specify a price; it is executed at the best possible price available. A market order can keep the customer from ‘chasing’ a market.

The most common type of order is the Market Order. If you enter a Market Order, you state the number of contracts you want to buy or sell in a given contract month. You do not specify a price, since your objective is to have the order executed as soon as possible at the best possible price. Once a Market Order is placed it is filled and cannot be cancelled.

The presence of the Market Style indicates to the VAO that the distilled order to be submitted to the Exchange is a Market Order.

| Special Fields | Description |
|---|---|
| OrderQty | Volume |
| Side | |
| Symbol | Security |

The limit style indicates that the order is an order to buy or sell at a designated price. Limit Orders to buy are placed below the current price while limit orders to sell are placed above the current price. Even though you may see the market touch a limit price several times, this does not guarantee or earn the customer a fill at that price. In most instances, the market must trade better than the limit price for the customer to get a fill. (The notable exception is SFE, where a Limit is explicitly for the Price specified and NOT implicitly “or better”)

A Limit Order specifies a-price limit at which the order must be executed. In other words, it must be filled at that price or better. The advantage is that you know the worst price you will get if the order is executed. The disadvantage is that you cannot be certain that the order will be filled.

When buying, if the order price is lower than (below) the current market price, it is a Buy Limit.
As an example, with the market trading at 250,
Buy 1 Dec FTSE100 @ 250 on a Limit (or better . . . fill at 250 or lower).
Order can only be filled at the stated price (250) or lower (better).

When selling, if the order price is higher than (above) the current market price, it is a Sell Limit.
As an example, with the market trading at 250,
Sell 1 Dec FRSE100 @ 255 on a Limit (or better . . . fill at 255 or higher).
Can only be filled at the stated price (255) or higher (better).

If the limit style is present within the VAO Message the VAO system will submit a distilled limit order at a specified price.

| Special Fields | Description |
|---|---|
| OrderQty | Volume |
| Side | |
| Symbol | Security |
| Price | |

An existing order revision action is an action that edits an existing order. Typically this sort of action will be used in contingency type orders. The details needed for this type of action will include the BOID of the Existing Order plus revision details.

| Special Fields | Description |
|---|---|
| OrderQty | New volume |
| Price | New price |
| ESBOIDPrimary | Order Id of order to be revised |

An existing order cancellation action is an action that pulls an existing order. Typically this sort of action will be used in one-cancels-the-other type orders. The details needed for this type of action will include the BOID of the Existing Order.

| Special Fields | Description |
|---|---|
| ESBOIDPrimary | Order Id of order to be cancelled |

If the Cash Denominated style is added to a VAO, it will mean that the VAO system will automatically calculate the volume based on Cash/Capital submitted on the VAO Ticket.

| Special Fields | Description |
|---|---|
| CashOrderQty | The monetary value of the desired trade. |
| Currency | ISO standard currency code of the supplied Cash. If not |
| (optional) | supplied the Exchange Base Currency is assumed. |

Examples of events that may be implemented in the system described herein will now be set out in more detail.

If the Trigger Price event is added to a VAO, this will mean that the VAO system will take some “action” (eg. place a limit) if trigger conditions are met. The conditions/parameters are:

| Special Fields | Description |
|---|---|
| ESMonitorDirection | Direction - up(1), down(−1), don't care(0) |
| Side | |
| Symbol | Security |
| ESMonitorPrice | Price at which to fire trigger |

For optimisation this event when fired will return the volume in the market at the trigger price.

The Security, that the Trigger monitors, does NOT have to be the Security on which the “action” will take place.

If the Trigger Volume event is added to a VAO, this will mean that the VAO system will take some “action” (ea. place a limit) if trigger conditions are met. The conditions/parameters are:

| Special Fields | Description |
|---|---|
| ESMonitorDirection | Direction - up(1), down(−1), don't care(0) |
| ESMonitorVolume | Volume to watch for |
| Side | |
| Symbol | Security |
| ESMonitorPrice | If supplied the volume at this price is monitored |
| (optional) | |

For optimisation (when price is not supplied) this event when fired will return the price in the market at the trigger volume.

The Security, that the Trigger monitors, does NOT have to be the Security on which the “action” will take place.

If a Trailing Trigger Price event is added to a VAO, the VAO system will take some “action” (eg. place a limit) if trigger conditions are met. The conditions/parameters are:

| Special Fields | Description |
|---|---|
| ESMonitorDirection | Direction - up(1), down(−1), don't |
| | care(0) |
| ESMonitorPriceChangePercentage | % drift in price in direction specified |
| | that will fire the trigger. |
| ESMonitorPriceChangeTicks | Number of Ticks drift in direction |
| | specified that will fire the trigger. |
| Side | |
| Symbol | Security |

For optimisation this event when fired will return the volume and price in the market that triggered the event.

The Security, that the Trigger monitors, does NOT have to be the Security on which the “action” will take place.

If a Trailing Trigger Volume event is added to a VAO, the VAO system will take some “action” (eg. place a limit) if trigger conditions are met. The conditions/parameters are:

| Special Fields | Description |
|---|---|
| ESMonitorDirection | Direction - up, down, don't care |
| ESMonitorVolumeChangePercentage | % Change in direction |
| | specified that will fire the trigger. |
| ESMonitorVolumeChange | Volume Change in direction |
| | specified that will fire the trigger. |
| ESMonitorPrice (optional) | Price who's volume is to be |
| | monitored, if not supplied watch |
| | total volume for all prices |
| Side | |
| Symbol | Security |

For optimisation this event when fired will return the volume in the market that triggered the event.

The Security, that the Trigger monitors, does NOT have to be the Security on which the “action” will take place.

If the Immediate Fill event, is added to a VAO, the VAO system will take some “action” if trigger conditions are met. An example would be ‘if this event times out without firing then Cancel/Pull the Order’. The conditions/parameters are:

| Special Fields | Description |
|---|---|
| ESMonitorBOIDFillTimeOut | A timeout for which to wait for |
| | a fill . . . |
| ESMonitorBOIDPartialOrComplete | An indicator that means the event |
| | will distinguish between partial |
| | fills and complete fills. |

The Contingency event, if added to a VAO, will mean that the VAO system will take some “action” if trigger conditions on another order are met. An example would be ‘place Order Y if Order X fills’.

| Special Fields | Description |
|---|---|
| ESMonitorBOIDPrimary | Order Id or the order that this event will listen |
| | to. |
| ESMonitorBOIDEvent | An indicator as to what order event to listen |
| | for; say; fill (partial/complete), cancel |
| | etc . . . |

The On Open event indicates that an action is to be executed during the opening range of trading.

| | |
|---|---|
| Special Fields | Description |

ESMonitorTradSesStatus

The Not On Open event indicates that an action is to be executed outside the opening range of trading.

| | |
|---|---|
| Special Fields | Description |

ESMonitorTradSesStatus

The On Close event indicates that an action is to be executed during the closing range of trading.

| | |
|---|---|
| Special Fields | Description |

ESMonitorTradSesStatus

The Not On Close event indicates that an action is to be executed outside the closing range of trading.

| | |
|---|---|
| Special Fields | Description |

ESMonitorTradSesStatus

The Time Sliced event indicates that various actions are to be performed over slices of time. For example: A large volume is to be traded so sell 10% every 15 seconds.

| Special Fields | Description |
|---|---|
| ESVAOSlicePercentage | Percent Volume to be submitted in every slice |
| ESVAOSliceInterval | The time between slices |

If the Trigger Time event is added to an order, some “action” (eg. Pull Order X) will occur if at a certain date and time.

| Special Fields | Description |
|---|---|
| ESMonitorDateTime | UTC date time at which trigger is to be fired |

If the Risk Breach event is added to an order, some “action” (eg. Pull Order X) will occur should the Risk Limits of an Account be breached.

| Special Fields | Description |
|---|---|
| ESAccount | Account |
| ESRiskWarningLevel | |

If the P&L Change Percent event is added to an order, some “action” (e.g. Pull Order X) will occur should the Risk Limits of an Account be breached.

| Special Fields | Description |
|---|---|
| ESAccount | Account |
| Direction | |
| Special Fields | Description |
| ESMonitorDirection | Direction - up, down, don't care |
| ESMonitorVolumeChangePercentage | % Change in direction specified |
| | that will fire the trigger. |
| ESMonitorVolumeChange | Volume Change in direction |
| | specified that will fire the |
| | trigger. |
| ESMonitorPrice (optional) | Price who's volume is to be |
| | monitored, if not supplied |
| | watch total volume for all prices |
| Side | |
| Symbol | Security |

If the P&L Change Cash event is added to an order, some “action” (e.g. Pull Order X) will occur should the Risk Limits of an Account be breached.

| Special Fields | Description |
|---|---|
| ESAccount | Account |
| Direction | |
| Special Fields | Description |
| ESMonitorDirection | Direction - up, down, don't care |
| ESMonitorVolumeChangePercentage | % Change in direction specified |
| | that will fire the trigger. |
| ESMonitorVolumeChange | Volume Change in direction |
| | specified that will fire the |
| | trigger. |
| ESMonitorPrice (optional) | Price whose volume is to be |
| | monitored, if not supplied |
| | watch total volume for all prices |
| Side | |
| Symbol | Security |

In a highly preferred embodiment, any value added order (custom order) can be composed from the previously defined actions and events. That is, one or more actions and events can be combined to produce a new order type. The new order type may be used by the trader or administrator who composed the new type and/or the new order type may be made available to or transmitted to other traders, or a specific group of traders, using the trading system. Examples of some order types, which may be provided in the system or set up by a user, will now be provided.

An EasyStopMarket (EasyStop) is a custom order type, within the system, which automatically places a market order on the exchange when a price threshold is breached or hit. The Value Added Order system will implement an EasyStop by the combination of a Trigger Price Event and a Market Action.
Trigger Price Event
Market Order Place Action

When not supported directly by an Exchange an ‘Immediate or Cancel’ order can be implemented by the Value Added Order System by combination of a Limit Order with an Immediate Fill Event (partial). If the Immediate Fill Event times out then the Limit Order is pulled by the VAO system. If the Immediate Fill Event fires indicating a Partial Fill the remainder of the Limit Order is pulled.
Limit Order Place Action
Immediate Fill Event
Limit Order Pull Action

Some exchanges support these directly, however where not the VAO will implement this functionality via timeouts as described above. (The notable exception is SFE, where an IOC may not be immediate, on SFE the order may hang around for 30 seconds (if not filled))

When not supported directly by an Exchange a ‘Fill Or Kill’ or Cancel can be implemented by the Value Added Order System by combination of a Limit Order Place Action, Trigger Volume (with Price) Event and an Immediate Fill Event (complete). If the Trigger Volume (with Price) is fired a Limit Order placed with an Immediate Fill Event. If the Immediate Fill Event times out then the Limit Order is pulled by the VAO system.

There is scope for a partial fill occurring.
Trigger Volume (with Price) Event
Limit Order Place Action
Immediate Fill Event
Limit Order Pull Action

Some exchanges support these directly, however where not the VAO will implement this functionality by only submitting the order where the available volume in the market is greater than or equal to desired volume.

An ‘IceBerg’ is an Order that takes a volume (and price if Limit) and a Tranche size. The Tranche will always be less than or equal to the volume or the Order. The Order is submitted in Tranches i.e. one Tranche at a time. The Tranche Orders are each submitted as Day Limit Orders. Only when one is filled is the next submitted. Some exchanges do support these directly however where not supported the VAO will provide support by monitoring the fill status of the previously submitted tranche. Icebergs may be implemented within the VAO as a chain of Orders Placements that are contingent on preceding Fills.

| Special Fields | Description |
|---|---|
| Symbol | Security |
| Price (optional) | Price where to place the tranches |
| ESVAOTotalVolume | The total volume that the trader |
| | wishes to trade |
| ESVAOTrancheNumber | May be derived from Tranche Volume |
| (optional) | |
| ESVAOTrancheVolume | May not be specified as random |
| (optional) | tranche volumes hide trader goals |
| | more effectively from the market. |
| ESVAOTranchRandomVolume | A Boolean indicator |
| | If true use random tranche volumes |

Limit Order Place Action
Contingent on Order Fill Event

An ‘Invisible’ is quite an intelligent order style. The Order sits within the VAO monitoring the Market for a price. If volume becomes available in the market at the specified price an IOC with matching volume is issued to trade against this volume. The Invisible then returns to watch mode within the VAO system, should more volume become available at this watch price then further IOC's will be issued.

| Special Fields | Description |
|---|---|
| Symbol | Security |
| Price | Price to watch for |
| ESVAOTotalVolume | The total volume that the |
| | trader wishes to trade |

Trigger Price Event (return Volume @ Price)
Limit Order Placement Action

The ‘One Cancels the Other’ (OCO) order style implies a pairing between orders whereby should an “event” occur on one then another “action” is performed. This particular case is a combination of two orders written on one order ticket. Using this order style means that once one side of the order is filled, the remaining side of the order should be cancelled. By placing both instructions on one order, rather than two separate tickets, the customer eliminates the possibility of a double fill. That is, One (order) Cancels (the) Other.

As an example, with the market trading at 375 you want to buy at 370 Limit (lower), or on an upside breakout at 380 Stop (higher),
Buy 1 Dec Wheat 370 on a Limit, OCO
Buy 1 Dec Wheat 380 Stop.

Whichever order is executed first, causes the other to be automatically cancelled.

| | |
|---|---|
| Special Fields | Description |

Both Order Details

Where not supported by the Exchange the VAO system may implement OCOs by placing 2-way contingencies between the orders, so that when one fills the other is pulled.
Contingency on Fill (complete)×2
Limit Order Pull Action×2

Further order types may include:

### New Order Contingent on Event on Existing Order—EasyIceberg

### New Order Contingent on Event on New Order—EasyCross

Existing Order Action Contingent on Event on Existing Order—Cancel One Order upon Fill of another

### Existing Order Action Contingent on Event on New Order—Replacement

A ‘One Contingent on the Other’ order type implies a pairing between orders whereby should an “event” occur on one then another “action” is performed.
As an example,
Place an order and then contingent on first order being filled place another order. For example, 1 ZX 4000 OCO −1ZX 3500 on stp contingent on +1 ZX 3700.

| | |
|---|---|
| Special Fields | Description |

Child Order Details

Where not supported by the Exchange the VAO system will implement One Contingent on the Other by placing a contingency between the orders, so that when one fills the other is placed.
Contingency on Fill (complete)
Limit Order Place Action

All orders, Except Market Orders, can be cancelled and replaced with a different order unless filled prior to cancellation, i.e. ‘Enter and Cancel’ order
As an example, you are long 1 Dec FFSE100 and have a GTC order to sell 1 Dec FTSE100 @ 3700 Stop. With the market trading at 3800, you decide to sell your 1 long Dec FYSE100 on a Market order,
Sell 1 Dec FFSE100 @ Market, Cancel selling 1 Dec FFSE100 3700 Stop on GTC order No. 12345.

| Special Fields | Description |
|---|---|
| Order to replace details | BOID |

Where not supported by the Exchange the VAO system will implement Enter and Cancel order using:
Contingency on Place
Limit Order Pull Action

### Flatten Position Hard

The required Market Orders necessary to flatten the position of an Account are automatically submitted. This Action is a multi-tranche trade.

| Special Fields | Description |
|---|---|
| ESAccount | Account |

### Flatten Position Soft

The required Stop Orders necessary to flatten the position of an Account are automatically submitted. This Action is a multi-tranche trade. The cash amount or percentage supplied is the amount by which the overall position cannot be allowed to worsen. The Stop Orders are placed with trigger prices such that the overall position will not worsen by more than the supplied cash amount or percentage.

| Special Fields | Description |
|---|---|
| ESAccount | Account |
| Soft Flatten Stop | The percentage off the current price |
| Percentage | at which Stops are to be placed. |
| | Effectively |

### Auto Flatten Position Hard

The required Market Orders necessary to flatten the position of an Account are automatically submitted upon breach of Risk Limits. This Action is a multi-tranche trade.

| Special Fields | Description |
|---|---|
| ESAccount | Account |

### Auto Flatten Plosition Sort

The required Stop Orders necessary to flatten the position of an Account are automatically submitted upon breach of Risk Limits. This Action is a multi-tranche trade. The cash amount or percentage supplied is the amount by which the overall position cannot be allowed to worsen. The Stop Orders are placed with trigger prices such that the overall position will not worsen by more than the supplied cash amount or percentage.

| Special Fields | Description |
|---|---|
| ESAccount | Account |
| Soft Flatten Stop | The percentage off the current price |
| Percentage | at which Stops are to be placed. Effectively |

Once an order type has been selected, or a new order set up, a trader may simply enter parameters, such as the volume and stop price, in an order ticket. In some embodiments, parameters may be set to default values, which may be changed by the trader. For example, a particular trader may have a default volume amount for an order, for example an Iceberg order. This may increase the speed at which the trader can send the order to market. In addition, repeated orders from a trader may automatically be filled using the values that were submitted in the previous order.

New order types may be shared between traders, for example by being made available on a central system or by enabling traders to send tickets to each other.

Examples of Order Type Primitives according to one embodiment will now be described. These examples are non-limiting and it will be clear to one skilled in the art that other order type primitives may be provided. These primitives are low-level, and combinations thereof constitute Value Added Orders.

Easy—Where an Exchange does not support an Order Type the VAO will provide “Easyscreen” Valued Added Functionality that will mimic the said Order Type.

Market—A market order does not specify a price; it is executed at the best possible price available. A market order can keep the customer from ‘chasing’ a market.

The most common type of order is the Market Order. If you enter a Market Order, you state the number of contracts you want to buy or sell in a given contract month. You do not specify a price, since your objective is to have the order executed as soon as possible at the best possible price. Once a Market Order is placed it is filled and cannot be cancelled.

Limit—The limit order is an order to buy or sell at a designated price. Limit Orders to buy are placed below the current price while limit orders to sell are placed above the current price. Even though you may see the market touch a limit price several times, this does not guarantee or earn the customer a fill at that price. In most instances, the market must trade better than the limit price for the customer to get a fill.

A Limit Order specifies a price limit at which the order must be executed. In other words, it must be filled at that price or better. The advantage is that you know the worst price you will get if the order is executed. The disadvantage is that you cannot be certain that the order will be filled. When buying, if the order price is lower than (below) the current market price, it is a Buy Limit.
As an example, with the market trading at 250,
Buy 1 Dec FTSE100 @ 250 on a Limit (or better fill at 250 or lower).
Order can only be filled at the stated price (250) or lower (better).

When selling, if the order price is higher than (above) the current market price, it is a Sell Limit.
As an example, with the market trading at 250,
Sell 1 Dec FTSE100 @ 255 on a Limit (or better . . . fill at 255 or higher).
Can only be filled at the stated price (255) or higher (better).

Trigger Price—This feature if added to an order will mean that some “action” (eg. place a limit) will occur if trigger conditions are met. The conditions are: Price, Side, Direction.

Trigger Volume—This feature if added to an order will mean that some “action” (eg. place a limit) will occur if trigger conditions are met. The conditions are: Volume, Side.

Trailing Trigger Price—This feature if added to an order will mean that some “action” (eg. place a limit) will occur if trigger conditions are met. The conditions are: % or Number of Ticks, Side, Direction.

Trailing Trigger Volume—This feature if added to an order will mean that some “action” (eg. place a limit) will occur if trigger conditions are met. The conditions are: % Volume Change or Volume Change, Side, Direction.

Cash Denominated—This feature if added to an order will mean that the VAO system will automatically calculate the volume based on Cash/Capital submitted on the VAO Ticket.

Immediate Or Cancel—An Immediate or Cancel is an order, that is submitted at a specified price . . . if no fills (even partial) do not occur immediately then the order is pulled. In the case of immediate partial fill the remainder is pulled. Thereby not exposing the trader

Fill Or Kill—This order style indicates that the VAO should only submit the order where volume in the market is greater than or equal to desired volume.

Iceberg—An IceBerg is an Order that takes a volume (and price if Limit) and a Tranche size. The Tranche will always be less than or equal to the volume or the Order. The Order is submitted in Tranches . . . ie. One Tranche at a time. The Tranche Orders are each submitted as Day Limit Orders. Only when one is filled is the next submitted. Some exchanges do support these.

Invisible—An Invisible is more intelligent variation of the above. The Order sits within the VAO monitoring the Market for a price. If volume becomes available in the market at the specified price and IOC with matching volume is issued to trade against this volume. The Invisible then returns to watch mode within the VAO system, should more volume become available at this watch price then further IOC's will be issued.

One Cancels the Other (OCO)—This is a combination of two orders written on one order ticket. This instructs the floor broker that once one side of the order is filled, the remaining side of the order should be cancelled. By placing both instructions on one order, rather than two separate tickets, the customer eliminates the possibility of a double fill. One (order) Cancels (the) Other.
As an example, with the market trading at 375 you want to buy at 370 Limit (lower), or on an upside breakout at 380 Stop (higher),
Buy 1 Dec Wheat 370 on a Limit, OCO
Buy 1 Dec Wheat 380 Stop.
Whichever order is executed first, causes the other to be automatically cancelled.

One Contingent on the Other—This order style indicates implies a pairing between orders whereby should an “event” occur on one then another “action” is performed.
As an example,
Place an order and then contingent on first order being filled place another order. Eg −1 ZX 4000 OCO −1ZX 3500 on stp contingent on +1 ZX 3700.

Enter and Cancel Order—All orders, Except Market Orders, can be cancelled and replaced with a different order unless filled prior to cancellation.
As an example, you are long 1 Dec Live Cattle and have a GTC order to sell 1 Dec Live Cattle @ 7700 Stop. With the market trading at 7800, you decide to sell your 1 long Dec Live Cattle on a Market order,
Sell 1 Dec Live Cattle @ Market, Cancel selling 1 Dec Live Cattle 7700 Stop on GTC order No. 12345.

On Open—This is an order style that indicates that an action is to be executed during the opening range of trading.

On Close—This is an order style that indicates that an action is to be executed during the closing range of trading.

Time Sliced—This order style indicates that various actions are to be performed over slices of time.
For example: A large volume is to be traded so sell 10% every 15 seconds.

Trigger Time—This feature if added to an order will mean that some “action” (eg. Pull Order X) will occur if at a certain date and time.

Examples of order types that could be covered within the Value Added Order System (VAO) will now be described. These examples are not intended to be limiting, but it will be clear to one skilled in the art that further order types may be provided. The order types are listed and described and are followed by examples of VAO simulated versions of the order types.

Market Order—A market order does not specify a price; it is executed at the best possible price available. A market order can keep the customer from ‘chasing’ a market. The most common type of order is the Market Order. If you enter a Market Order, you state the number of contracts you want to buy or sell in a given contract month. You do not specify a price, since your objective is to have the order executed as soon as possible at the best possible price. Once a Market Order is placed it is filled and cannot be cancelled.

Easy Market Order—Where an Exchange does not support Market Orders we could simulate these within the Value Added Order system as follows:
Submit Immediate or Cancel (Fill or Kill) at the Market Price determined from the Market Data Feed.

Limit Order—The limit order is an order to buy or sell at a designated price. Limit Orders to buy are placed below the current price while limit orders to sell are placed above the current price. Even though you may see the market touch a limit price several times, this does not guarantee or earn the customer a fill at that price. In most instances, the market must trade better than the limit price for the customer to get a fill.

A Limit Order specifies a price limit at which the order must be executed. In other words, it must be filled at that price or better. The advantage is that you know the worst price you will get if the order is executed. The disadvantage is that you cannot be certain that the order will be filled.

When buying, if the order price is lower than (below) the current market price, it is a Buy Limit.
As an example, with the market trading at 250,
Buy 1 Dec FRSE100 @ 250 on a Limit (or better . . . fill at 250 or lower).
Order can only be filled at the stated price (250) or lower (better).

When selling, if the order price is higher than (above) the current market price, it is a Sell Limit.
As an example, with the market trading at 250,
Sell 1 Dec FFSE100 @ 255 on a Limit (or better . . . fill at 255 or higher).
Can only be filled at the stated price (255) or higher (better).

Or Better—The pit broker is obligated to get the best possible price for the customer. Think of OB as a market order with a limit. If the price does not have an OB next to it, and the market is considerably better, the pit broker may question the ruriner to see if the order should have been a stop. They may return the order for clarification, which could delay execution and possibly change the results of the fill.

Market If Touched (MIT)—Buy MITs are placed below the current price and Sell MITs are placed above the current price. An MIT order is similar to a limit order in that a specific price is placed on the order. However, an MIT order becomes a market order once the limit price is touched or passed through. An execution may be at, above, or below the originally specified price. If the market trades at the trade price, the order will be filled at the next best price. Can only be used on Limit orders (not Stops).

### Stop Market Order

Stop orders can be used for three purposes:
to minimize a loss on a long or short position
to protect a profit on an existing long or short position, or
to initiate a new long or short position.

A buy stop order is placed above the current market and is elected only when the market trades at or above, or is bid at or above, the stop price. A sell stop order is placed below the current market and is elected only when the market trades at or below, or is offered at or below, the stop price. Once the stop order is elected, the order is treated like a market order and will be filled at the best possible price.

Stop Market Orders are not executed until the market reaches a given price, at which time they become Market Orders (or Easy Market Orders).

When buying, if the order price is higher than (above) the current market price, it is a Buy Stop.
As an example, with the market trading at 335,
Buy 1 Dec FTSE100 @ 335 Stop.
Can only be filled at the Market, after the Market trades (or is “bid”) at 335 or higher.

When selling, if the order price is lower than (below) the current market price, it is a Sell Stop
As an example, with the market trading at 335,
Sell 1 Dec FTSE100 @ 330 Stop.
Can only be filled at the Market, after the Market trades (or is “offered”) at 330 or lower.

Easy Stop Market Order—Where the Exchange does not support Stop Market Orders we can simulate Stop Market Orders within the Value Added Order system as follows:
Listen to the Market Data
When the Stop Price is triggered submit a Market Order (or Easy Market Order see above) to the Exchange.

Stop Limit Order—A stop limit order lists two prices and is an attempt to gain more control over the price at which your stop is filled. The first part of the order is written like the above stop order. The second part of the order specifies a limit price. This indicates that once your stop is triggered, you do not wish to be filled beyond the limit price. Stop limit orders should usually not be used when trying to exit a position.

Easy Stop Limit Order—Where the Exchange does not support Stop Limit Orders we can simulate Stop Limit Orders within the Value Added Order system as follows:
Listen to the Market Data
When the Stop Price is triggered submit a Limit to the Exchange.

Trailing Market Stop—A Trailing Market Stop, a stop order, is triggered if the market moves (direction specified) by the specified percentage or number of ticks.

Easy Trailing Market Stop—Where an Exchange does not support Trailing Market Stops (most cases) the Value Added Order system could simulate this as follows:
The Order with the ancillary parameters (direction, %, number of ticks) is submitted to the VAO.
The VAO then monitors price movements on the security.
Should the market move by the specified %/number of ticks in the direction specified then the VAO1 submits a Market Order (or Easy Market Order).

Trailing Limit Stop—A Trailing Limit Stop, a stop order, is triggered if the market moves (direction specified) by the specified percentage or number of ticks.

Easy Trailing Market Stop—Where an Exchange does not support Trailing Limit Stops (most cases) the Value Added Order system could simulate this as follows:
The Order with the ancillary parameters (direction, %, number of ticks) is submitted to the VAO.
The VAO then monitors price movements on the security.
Should the market move by the specified %/number of ticks in the direction specified then the VAO submits a Limit Order.

Stop Market Open Only:—The stop price on a stop open only will only be triggered if the market touches the stop price during the opening of trading, resulting in the submission of a Market Order. If nothing happens (ie. Stop Price not hit) during the open period the Market Order will decay.

Easy Stop Market Open Only—Where the Exchange does not support Stop Market Open Orders we can simulate these orders within the Value Added Order system as follows:
Listen to Market Modes on a particular Contract
When this Market Mode switches to Open (eFIXSecurityTradingStatusOpen) we are deemed to be in the open period.
This window lasts for a configurable amount of time (defined by us)
If the Stop Price is triggered within this open period then a Market Order (or Easy Market Order) is submitted.
If the Stop Price is not triggered within the open period then it decays, and informs the Trader

Stop Limit Open Only—The stop price on a stop open only will only be triggered if the market touches the stop price during the opening of trading, resulting in the submission of a Limit Order. If nothing happens (ie. Stop Price not hit) during the open period the Limit Order will decay. Will protect the Trader from adverse conditions within the open period.

Easy Stop Limit Open Only—Where the Exchange does not support Stop Limit Open Orders we can simulate these orders within the Value Added Order system as follows:
Listen to Market Modes on a particular Contract
When this Market Mode switches to Open (eFIXSecurityTradingStatusOpen) we are deemed to be in the open period.
This window lasts for a configurable amount of time (defined by us)
If the Stop Price is triggered within this open period then a Limit Order is submitted.
If the Stop Price is not triggered within the open period then it decays, and informs the Trader.

Stop Market Close Only—The stop price on a stop market close only will only be triggered if the market touches the stop during the close of trading. The disadvantage of this order is a fast market in the last few minutes of trading may cause the order to be filled at an undesirable price. It can, however, protect the customer from getting filled during adverse price fluctuations during the course of the day.

Easy Stop Market Close Only—If not supported by an Exchange we can simulate this within the Value Added Order system as follows:
Listen to Market Modes on a particular Contract
When this Market Mode switches to Pre-Close (eFIXSecurityTradingStatusPreClose) we are deemed to be in the close period.
This close period lasts until receipt of Close (eFIXSecurityTradingStatusClosed) or a configurable amount of time is Close is not available (defined by us)
If the Stop Price is triggered within this close period then a Market Order (or Easy Market Order) is submitted.
If the Stop Price is not triggered within the close period then it decays, and informs the Trader.

The advantages and, disadvantages of this order type are the same as for Stop Market Close Only orders.

Stop Limit Close Only—The stop price on a stop limit close only will only be triggered if the market touches the stop during the close of trading. The advantage of this order type over a stop market close only is that it protects the trader from getting filled during adverse price fluctuations during the close period. The disadvantage, fills are not guaranteed.

Easy Stop Market Close Only—If stop limit close only is not supported by an Exchange we can simulate this within the Value Added Order system as follows:
Listen to Market Modes on a particular Contract
When this Market Mode switches to Pre-Close (eFIXSecurityTradingStatusPreClose) we are deemed to be in the close period.
This close period lasts until receipt of Close (eFIXSecurityTradingStatusClosed) or a configurable amount of time is Close is not available (defined by us)
If the Stop Price is triggered within this close period then a Limit is submitted.
If the Stop Price is not triggered within the close period then it decays, and informs the Trader.

The advantages and disadvantages of this order type are the same as for Stop Limit Close Only orders.

Market On Opening (MOO)—This is an order that the customer wishes to be executed during the opening range of trading at the best possible price obtainable within the opening range.

Easy Market On Opening—EasyMOO—Where an Exchange does not support Market On Open we can simulate this within the Value Added Order system as follows:
Listen to Market Modes on a particular Contract
When this Market Mode switches to Open (eFIXSecurityTradingStatusOpen) we are deemed to be in the open period.
This window lasts for a configurable amount of time (defined by us)
Once in this open period a Market Order is submitted to the Exchange.
If for any reason (error etc. . . . ) the submission of the Market Order fails then the VAO will retry to submit the Market Order until the end of the open period

Limit On Opening (LOO):—This is an order that the customer wishes to be executed during the opening range of trading at the specified price within the opening range.

Easy Limit On Opening—EasyLOO—Where an Exchange does not support Market On Open we can simulate this within the Value Added Order system as follows:
Listen to Market Modes on a particular Contract
When this Market Mode switches to Open (eFIXSecurityTradingStatusOpen) we are deemed to be in the open period.
This window lasts for a configurable amount of time (defined by us)
Once in this open period a Market Order is submitted to the Exchange.
If for any reason (error etc. . . . ) the submission of the Market Order fails then the VAO will retry to submit the Market Order until the end of the open period.

Market On Close (MOC)—This is an order that will be filled during the final minutes of trading at whatever price is available. Market On Close. Order will be filled at Market within the closing price range.

Easy Market On Close (EasyMOC)—If a Market On Close is not supported by an Exchange we can simulate this within the Value Added Order system as follows:
Listen to Market Modes on a particular Contract
When this Market Mode switches to Pre-Close (eFIXSecurityTradingStatusPreClose) we are deemed to be in the close period.
This close period lasts until receipt of Close (eFIXSecurityTradingStatusClosed) or a configurable amount of time is Close is not available (defined by us)
A Market Order is then submitted by the Value Added Order system.
If for any reason (error etc. . . . ) the submission of the Market Order fails then the VAO will retry to submit the Market Order until the end of the open period.

Limit On Close (LOC)—This is a Limit Order that will be submitted during the final minutes of trading at the specified price. Order may not be Filled.

Easy Limit On Close (EasyLOC)—If a Limit On Close is not supported by an Exchange we can simulate this within the Value Added Order system as follows:
Listen to Market Modes on a particular Contract
When this Market Mode switches to Pre-Close (eFIXSecurityTradingStatusPreClose) we are deemed to be in the close period.
This close period lasts until receipt of Close (eFIXSecurityTradingStatusClosed) or a configurable amount of time is Close is not available (defined by us)
A Limit Order is then submitted by the Value Added Order system.
If for any reason (error etc. . . . ) the submission of the Limit Order fails then the VAO will retry to submit the Limit Order until the end of the open period.
However if the order is rejected (outside price limits) then no-resubmission occurs.

Immediate Or Cancel—An Immediate or Cancel is an order, that is submitted at a specified price . . . if no fills (even partial) do not occur immediately then the order is pulled. In the case of immediate partial fill the remainder is pulled. Thereby not exposing the trader.

Easy Immediate Or Cancel—Where and Exchange does not support Immediate or Cancel we could simulate these to a degree. The VAO monitor market volume and if any volume exists then a Limit Order for that volume would be submitted to the Exchange. If there is no volume in the market the VAO would reject the order.

Iceberg—An IceBerg is an Order that takes a volume (and price if Limit) and a Tranche size. The Tranche will always be less than or equal to the volume or the Order. The Order is submitted in Tranches . . . ie. One Tranche at a time. The Tranche Orders are each submitted as Day Limit Orders. Only when one is filled is the next submitted. Some exchanges do support these.

Easy Iceberg—An iceBerg is an Order that takes a volume (and price if Limit) and a Tranche size. The Tranche will always be less than or equal to the volume or the Order. The Order is submitted in Tranches . . . ie. One Tranche at a time. The Tranche Orders are each submitted as Day Limit Orders. Only when one is filled is the next submitted. Note: the Tranche could also be set to be random . . . to further disguise Trader intentions

Invisible—An Invisible is more intelligent variation of the above. The Order sits within the VAO monitoring the Market for a price. If volume becomes available in the market at the specified price and TOC with matching volume is issued to trade against this volume. The Invisible then returns to watch mode within the VAO system, should more volume become available at this watch price then further IOC's will be issued.

One Cancels the Other (OCO)—This is a combination of two orders written on one order ticket. This instructs the system that once one side of the order is filled, the remaining side of the order should be cancelled. By placing both instructions on one order, rather than two separate tickets, the customer eliminates the possibility of a double fill.

One (order) Cancels (the) Other.
As an example, with the market trading at 375 you want to buy at 370 Limit (lower), or on an upside breakout at 380 Stop (higher),
Buy 1 Dec Wheat 370 on a Limit, OCO
Buy 1 Dec Wheat 380 Stop.

Whichever order is executed first, causes the other to be automatically cancelled.

Good Till Cancelled Order (GTC)—Good Till Cancelled (or Open Order). Used in conjunction with a Limit or Stop order. Order will remain valid and worked until client cancels order, or it is filled, or contract expires. GTC Order Does Not Cancel Automatically!
As an example, you are 1 long Sep 04 Sterling and have a GTC order to sell Dec 04 Sterling @ 98 Stop. You decide to sell your 1 long Sep 04 Sterling on a Market order.
Your GTC order must be cancelled . . . or you will sell (short) 1 Dec 04 Sterling if the mnarket trades (or is “bid”) at 98 or lower.

Day Order—If an order is not designated Good Till Cancelled, it is a Day Order and will expire at the end of the current trading session unless filled or cancelled prior to the close.

Enter and Cancel Order—All orders, Except Market Orders, can be cancelled and replaced with a different order unless filled prior to cancellation.
As an example, you are long 1 Dec Live Cattle and have a GTC order to sell 1 Dec Live Cattle @ 7700 Stop. With the market trading at 7800, you decide to sell your 1 long Dec Live Cattle on a Market order,
Sell 1 Dec Live Cattle (Market, Cancel selling 1 Dec Live Cattle 7700 Stop on GTC order No. 12345.

Time Delayed Orders may also be implemented using embodiments of the present system.

Risk Management mays also be implemented in conjunction with the present system, for example, the system mayintegrate with a separate risk management system.

For example, when an Iceberg is being placed; say 100 lot in 10 lot tranches the risk management system may take a worst-case scenario outlook. When each Tranche is being placed it is not risk permissioned again. However the individual Tranches do impact position.

In the same way the risk management system may take a worst-case scenario approach to VAOs. For example, a VAO Iceberg may be placed; say 100 lots in 10 lot tranches and the entire volume may be risk permissioned before set-up within the VAO. If permitted by the risk management system, the VAO system sets up internal triggers etc. As each tranche is filled the account position is updated. However: should a VAO be paused then only those previously filled orders will be taken into account for P&L. ie. the worst-case scenario will no longer apply.

VAOs are preferably risk permissioned at the outset taking the worst-case scenario into account and reflecting this within the potential position. Distilled orders will not be permissioned again but may impact the outright position. This may mean an additional flag on the placeorder stored procedure, as this is where permissioning and position calculations are performed.

For example, implement risk management in conjunction with the present system may impact components of the system in a number of ways.

| Component | Details of Change |
|---|---|
| EAT | Will need to reflect VAO permissioned status |
| EasyShield DB | Risk Permissioning and Position tables and |
| | stored procedure will need to be modified. As |
| | Actual/Distilled Orders cannot be double |
| | permissioned if the entire VAO has already |
| | been Risk Permissioned. |
| RiskPusher | Will need to be VAO aware and potentially |
| | have special handling for VAOs and their |
| | actual/distilled orders |
| EasyRouterAdmin | Risk View and Status screens and logic |
| | will need to reflect VAO impact on |
| | Risk Permissioning and Position |
| Business Objects | Existing Business Objects will need to be |
| | VAO aware . . . so as to prevent |
| | things like double-permissioning. |
| Database | Existing storedprocedures and views will need to |
| | be altered to take VAOs in account. |
| VAOPusher | Where Risk Permissioning reject a placement/ |
| | revision then the VAOPusher will need to relay |
| | information to the EAT client. |

Orders which submit 10%, 20%, 10%, 30% etc . . . of the total volume over a period of time. Could be quite useful for Traders wishing to submit large volumes automatically over a period, eg. 5000 lot submitting 2% every 20 seconds.

1. A trading system comprising:
means for receiving an order via a trading interface, wherein the order relates to a trading element on an exchange, the order having at least one associated predetermined condition;
means for determining the data required to fulfil the one or more predetermined conditions associated with the order;
means for obtaining the data required from an external source;
means for monitoring the data obtained to determine whether the one or more predetermined conditions associated with the trading order are fulfilled;
means for placing one or more distilled orders on the exchange if the one or more predetermined conditions associated with the order are fulfilled;
means for displaying the order as a single filled or unfilled order at the trading interface.

2. A trading system for enabling a trader to trade trading elements in a trading environment, the system comprising:
means for storing a plurality of predefined order types;
an interface for enabling a trader to enter an order for at least one trading element based on a predefined order type, wherein entering the order comprises defining values for a plurality of parameters associated with the predefined order type;
means for analyzing the order to divide the order into at least one monitoring condition and at least one distilled order element;
monitoring means for obtaining data from an external source to determine whether the monitoring condition is fulfilled;
means for placing the at least one distilled order element into the trading environment if, the monitoring condition is fulfilled.

3. A trading system for enabling a trader to trade trading elements in a trading environment, the system comprising:
means for storing a plurality of predefined order types, wherein each order types comprises at least one monitoring condition and at least one distilled order element;
an interface for enabling a trader to create a new order type by combining at least one monitoring condition and at least one distilled order element;
an interface for enabling a trader to enter an order for at least one trading element based on a predefined order type or the new order type;
means for enabling a plurality of traders to enter orders based on the new order type;
means for analyzing the order to divide the order into at least one monitoring condition and at least one distilled order element;
monitoring means for obtaining data from an external source to determine whether the monitoring condition is fulfilled;
means for placing the at least one distilled order element into the trading environment if the monitoring condition is fulfilled.

4. A system according to claim 1 or 2 wherein entering an order based on at least one order type generates a plurality of distilled order elements.

5. A system according to any preceding claim wherein at least one order type comprises a conditional order type.

6. A system according to any preceding claim wherein a distilled order element comprises at least one of:
an order to buy a predetermined volume of an asset;
an order to sell a predetermined volume of an asset.

7. A system according to any preceding claim wherein the monitoring condition is based on at least one of:
market data;
the status of an order or a distilled order element;
risk data, in particular the volatility of an asset;
the time and/or date;
external data.

8. A system according to claim 7 wherein market data comprises at least one of:
the buy or sell price of a trading element;
the mode of the market;
the volume of a trading element;
a change in the price of a trading element;
the rate of change of the price of a trading element;
a change in the volume of a trading element;
the rate of change of the volume of a trading element;
the time to the close of the market.

9. A system according to claim 2 wherein the plurality of parameters associated with the predefined order type include at least one of:
a buy/sell price for the order;
a volume of the trading element for the order;
a maximum total value for the order.

10. A system according to any preceding claim further comprising means for determining a risk value associated with the entered order before placing the at least one distilled order element on the exchange.

11. A system according to claim 10 wherein the risk value is calculated based on SPAN data for the order.

12. A system according to any preceding claim wherein the exchange comprises a trading exchange for at least one of:
shares;
commodities;
options;
futures;
currencies.

13. A system according to any preceding claim further comprising means for enabling a trader to cancel, edit, pause and/or play orders.

14. A system according to any preceding claim wherein placing a distilled order element on the exchange is dependent on the status of an existing distilled order element on the exchange.

15. A system according to any preceding claim wherein the monitoring condition is associated with a first trading element on the market and the distilled order element is associated with a second trading element.

16. A method of operating a trading system, the method comprising:
receiving an order via a trading interface, wherein the order relates to a trading element on an exchange, the order having at least one associated predetermined condition;
determining the data required to fulfil the one or more predetermined conditions associated with the order;
obtaining the data required from an external source;
monitoring the data obtained to determine whether the one or more predetermined conditions associated with the trading order are fulfilled;
placing one or more distilled orders on the exchange if the one or more predetermined conditions associated with the order are fulfilled;
displaying the order as a single filled or unfilled order at the trading interface.

17. A method for enabling a trader to trade trading elements in a trading environment, the method comprising:
storing a plurality of predefined order types;
receiving an order entered by the trader for at least one trading element based on a predefined order type, wherein entering the order comprises defining values for a plurality of parameters associated with the predefined order type;
analyzing the order to divide the order into at least one monitoring condition and at least one distilled order element;
obtaining data from an external source to determine whether the monitoring condition is fulfilled;
placing the at least one distilled order element into the trading environment if the monitoring condition is fulfilled.

18. A method for enabling a trader to trade trading elements in a trading environment, the method comprising:
storing a plurality of predefined order types, wherein each order types comprises at least one monitoring condition and at least one distilled order element;
receiving an order from a trader to create a new order type, wherein the order type is created by combining at least one monitoring condition and at least one distilled order element;
receiving an order from a trader for at least one trading element based on a predefined order type or the new order type;
enabling a plurality of traders to enter orders based on the new order type;
analyzing the order to divide the order into at least one monitoring condition and at least one distilled order element;
obtaining data from an external source to determine whether the monitoring condition is fulfilled;
placing the at least one distilled order element into the trading environment if the monitoring condition is fulfilled.

19. A computer program or computer program product comprising steps for implementing a method according to any of claims 16 to 18.

20. A computer program or computer program product comprising steps for implementing a method substantially as described herein.

21. A system or method substantially as described herein with reference to the figures.
